(19) United States
(12) Patent Application Publication
(10) Pub. No.: US 2026/0165221 A1
(43) Pub. Date: Jun. 18, 2026

(54) METHOD AND UTILITY VEHICLE FOR SETTING HEIGHT POSITION OF POWER LIFT

(71) Applicant: Deere & Company, Moline, IL (US)

(72) Inventor: Benedikt Wilhelm Peters, Grunstadt (DE)

(21) Appl. No.: 19/359,940

(22) Filed: Oct. 16, 2025

(30) Foreign Application Priority Data
Dec. 13, 2024 (EP) 24219746.5

(51) Int. Cl. A01B 63/112

(52) U.S. Cl. CPC A01B 63/112

(57) ABSTRACT

The disclosure relates to a method for setting a height position of a power lift mounted on a utility vehicle and coupled to an attachment for soil cultivation. A provided base characteristic curve represents a relationship between a target height position of the power lift and a tractive force expected on the power lift. For a selected target height position, the tractive force expected by the base characteristic curve is defined as a target tractive force . Depending on the target tractive force and an actual tractive force sensed at the power lift, a resulting height position of the power lift is determined and set. The disclosure also relates to a utility vehicle having a control unit for carrying out such a method.

### CROSS-REFERENCE TO RELATED APPLICATIONS

This application claims priority to European Patent Application No. 24219746.5, filed December 13, 2024, which is hereby incorporated by reference.

### TECHNICAL FIELD

The present disclosure relates generally to a method and a utility vehicle for setting a height position of a power lift which is mounted on the utility vehicle and is coupled to an attachment for soil cultivation.

### BACKGROUND

In agriculture, various attachments are used for soil cultivation. In many cases, the attachment is coupled to a power lift which is mounted on the utility vehicle so as to be adjustable in height. The power lift allows a variable working depth of the attachment by appropriate raising or lowering of the power lift. The setting of a height position of the power lift makes it possible to influence the working result during soil cultivation.

### SUMMARY

The disclosure addresses the problem of improving actuation of the power lift for setting the height positions thereof during soil cultivation.

This problem is solved by a method having the features of one or more embodiments disclosed herein and by a utility vehicle having the features of one or more embodiments disclosed herein.

Further advantageous embodiments of the disclosure can be found in the one or more embodiments disclosed herein.

According to one or more embodiments disclosed herein, a method is proposed for setting a height position of a power lift which is mounted on a utility vehicle and is coupled to an attachment for soil cultivation (for example a plow, harrow). In the method, a base characteristic curve is provided, which represents a relationship between a target height position of the power lift and a tractive force expected on the power lift for the particular target height position. For a selected target height position (for example a target height position selected by a user), the expected tractive force is defined as a target tractive force by means of the base characteristic curve. Depending on this target tractive force and an actual tractive force sensed (for example, by a sensor) at the power lift, a resulting height position is determined and set at the power lift.

Thus, a technical rule for setting the height of the power lift can be defined such that a defined target tractive force is maintained as precisely and constantly as possible. Under ideal and/or constant soil conditions, this corresponds to a constant height position of the power lift and thus to a desired constant working depth of the attachment. During soil cultivation, a defined target tractive force can be maintained as far as possible, i.e. deviations from the target tractive force can be minimized as far as possible in that the height position of the power lift is changed. As a result, even when there are topographical irregularities, a working depth of the attachment that is as constant as possible can be maintained. This in turn supports uniform growth of the seed introduced into the soil when there are irregularities within the field.

The definition of the target tractive force by means of the base characteristic curve provides an efficient prerequisite for technically precise reestablishment of a starting state of the power lift when the target tractive force and/or resulting height position thereof is intended to be changed during soil cultivation and the power lift is then intended to be transferred back into the starting state. In other words, reproducible adjustment behavior of the power lift during soil cultivation can be supported thereby.

An actuator (for example an electrically or hydraulically driven lifting cylinder) of the power lift can be actuated on the basis of the respectively determined resulting height position, in order to set this height position of the power lift. For example, the actuator is actuated by a suitable control unit which can determine the resulting height position taking input data (for example target height position, actual tractive force) and the base characteristic curve into consideration.

Also preferably, the determination of the resulting height position is supported by a provided adjustment characteristic curve, which represents a dependence between the resulting height position of the power lift and a deviation of the target tractive force from the actual tractive force. If appropriate, the abovementioned dependence can also comprise further criteria. The resulting height position can be automatically determined and set or adjusted on the basis of the adjustment characteristic curve without any control commands needing to be input by a user or driver of the utility vehicle for this purpose.

Advantageously, the adjustment characteristic curve is applied such that it intersects the base characteristic curve at a characteristic curve point which corresponds, on the base characteristic curve, to the selected target height position and the defined target tractive force. Such a combination of the adjustment characteristic curve with the base characteristic curve supports the determination and setting of optimized resulting height positions of the power lift.

The adjustment characteristic curve is advantageously designed such that the resulting height position is set to be lower than the selected target height position of the power lift when the actual tractive force is less than the target tractive force. Furthermore, the resulting height position is set to be higher than the selected target height position of the power lift when the actual tractive force is greater than the target tractive force. This adjustment behavior can be used, inter alia, to support maintenance of the defined target tractive force and/or a working depth of the attachment that is as constant as possible.

In an embodiment, a mathematical gradient of the adjustment characteristic curve is changeable. With this changeability, it is possible, for example, to choose that small deviations between the target tractive force and the actual tractive force sensed at the power lift are intended to generate greater changes in the height position of the power lift or that large deviations between the target tractive force and the actual tractive force sensed at the power lift are intended to generate smaller changes in the height position of the power lift. Thus, adjustment of the height position of the power lift can be adapted individually (for example to different soil types or different soil conditions within the same field). Consequently, setting that is as precise as possible of either a desired height position of the power lift or of a desired tractive force can be selectively prioritized. The gradient is set by an actuating element (for example a regulator) to be actuated by the user or driver.

Also, starting from the originally selected target height position of the power lift, by means of the operating element a different height position is able to be selected, which then corresponds to the currently selected target height position. In other words, the selected target height position is changeable. For this other selected target height position, the associated expected tractive force is then again defined as a changed target tractive force by means of the base characteristic curve. Thus, the user or driver themselves can change the height position of the power lift or the working depth of the attachment and influence the working result of soil cultivation if the current working result does not appear to be optimal.

Advantageously, starting from the changed target tractive force, a changed resulting height position of the power lift is also determined and set. This again takes place on the basis of the changed target tractive force and the actual tractive force sensed at the power lift and/or on the basis of the provided adjustment characteristic curve. The changed resulting height position can consequently be determined analogously to the original resulting height position. The provided adjustment characteristic curve can thus be applied in a manner shifted along the base characteristic curve in accordance with the target height position selected in a changed manner, without determining a changed resulting height position.

In a further embodiment, the selection of the target height position can be changed incrementally in that the abovementioned operating element realizes a forward step. The forward step can be effected, for example, by a mechanical movement (for example rotary or linear) of the operating element or by pressure application (for example pressing a push button) on the operating element. Thus, the target height position selected or to be selected can be changed as required in defined steps.

Also, starting from a changed resulting height position set by at least one forward step, the resulting height position from before the change can be set again. To this end, a number of backward steps of the operating element is carried out, which corresponds to the number of previously carried out forward steps. In this case, the combined use of the base characteristic curve and the adjustment characteristic curve makes it possible that, following the reversal of a changed resulting height position, the power lift can be returned to the original resulting height position again. Consequently, the power lift – in particular when there are irregular soil conditions – can be returned to the original adjustment behavior in a defined manner, with the result that the user or driver has greater operating comfort during soil cultivation when a desired working depth of the attachment is set.

The disclosure also relates to a utility vehicle on which a power lift is mounted, which is coupled to an attachment for soil cultivation. Furthermore, the utility vehicle has a force sensor for sensing an actual tractive force on the power lift, and a control unit for setting a height position of the power lift. For setting the height position, a base characteristic curve is provided (for example, in the control unit), said base characteristic curve representing a relationship between a target height position of the power lift and a tractive force expected on the power lift. For a selected target height position (for example a target height position selected by the user or driver), the tractive force expected by the base characteristic curve is able to be defined as a target tractive force. Depending on the target tractive force and the actual tractive force, a resulting height position of the power lift is able to be determined and set.

The utility vehicle according to the disclosure has the above-described advantages of the method according to the disclosure. In this case, when the height position is adapted, it is possible, for example, to avoid or minimize deviations from the defined target tractive force and/or from a desired working result during soil cultivation. For example, a defined target tractive force can be maintained automatically, and this can support a working depth of the attachment that is as constant as possible in particular when there are topographical irregularities. Furthermore, the provided base characteristic curve provides a technical simple prerequisite for transferring the power lift or the height position thereof back into the starting state in a precise manner when there are changes in the defined target tractive force and/or the resulting height position, as is often desired during soil cultivation. As a result, reproducible adjustment behavior of the power lift during soil cultivation is ensured using simple technical means.

Advantageously, the selected target height position is changeable such that the user or driver, in order to optimize the desired working result during soil cultivation, can work with different selected target height positions. Preferably, in order to change the target height position, an operating element to be actuated by the user or driver is provided, with the result that the selected target height position can be adapted easily in terms of control technology for example depending on a visual working result during soil cultivation.

The operating element is in the form, for example, of a movable element with a movement path (for example linear or rotary). The possible movement path can include several uniform movement steps such that a uniform change in the selected target height position is possible. The movement steps can be forward steps and/or backward steps depending on the direction (higher or lower) in which the selected target height position is intended to be changed. For instance, a defined movement path of the operating element corresponds to a predetermined target change in the selected target height position.

The operating element is in the form of a rotatable or rotary control wheel. The rotary movements thereof can have a movement path with different lengths and in the process correspond to the amount of the desired position change of the target height position. For example, the abovementioned forward or backward step of the operating element corresponds to a defined target change in the target height position along the provided base characteristic curve.

Also preferably, the rotatability of the control wheel is free of an end stop. Thus, rotary movements and movement paths of the control wheel can be defined independently of a minimum, maximum or current height position of the power lift. By a rotary movement of the control wheel, a defined change in the selected target height position of the power lift can be realized independently of the current rotary position of the control wheel and independently of the current height position of the power lift.

The power lift is constructed, for example, as a three-point power lift. Advantageously, the power lift is in the form of a rear power lift, which, mounted in the rear region of the utility vehicle, can be used for efficient soil cultivation.

Advantageously, the utility vehicle is an agricultural utility vehicle, in particular a tractor, which is combined with a power lift and an attachment for soil cultivation (for example in a field or meadow). Soil cultivation includes, for example, plowing the soil or soil preparation for planting seed or plants at a precise depth.

Other features and aspects will become apparent by consideration of the detailed description, claims, and accompanying drawings.

### BRIEF DESCRIPTION OF THE DRAWINGS

The disclosure will be explained in more detail in the following text with reference to the appended drawings. Components with an equivalent or comparable function are identified here by the same reference signs. In the figures:

FIG. 1 shows a schematic side view of a utility vehicle according to the disclosure with a power lift mounted thereon, and

FIG. 2 shows a diagram with a predetermined base characteristic curve for the method according to the disclosure, and

FIG. 3 shows an illustration in the manner of a block diagram with a control unit for actuating the power lift, and

FIG. 4 shows a diagram with a selected target height position of the power lift and a defined target tractive force, and

FIG. 5 shows the diagram according to FIG. 4 with a change in the selected target height position of the power lift, and

FIG. 6 shows the diagram according to FIG. 4 with a further change in the selected target height position, and

FIG. 7 shows the diagram according to FIG. 4 with a reversal of the selected target height position changed in FIG. 5 and FIG. 6, and

FIG. 8 shows the diagram according to FIG. 4 with differently settable gradients of an adjustment characteristic curve.

Like reference numerals are used to indicate like elements throughout the several figures.

### DETAILED DESCRIPTION

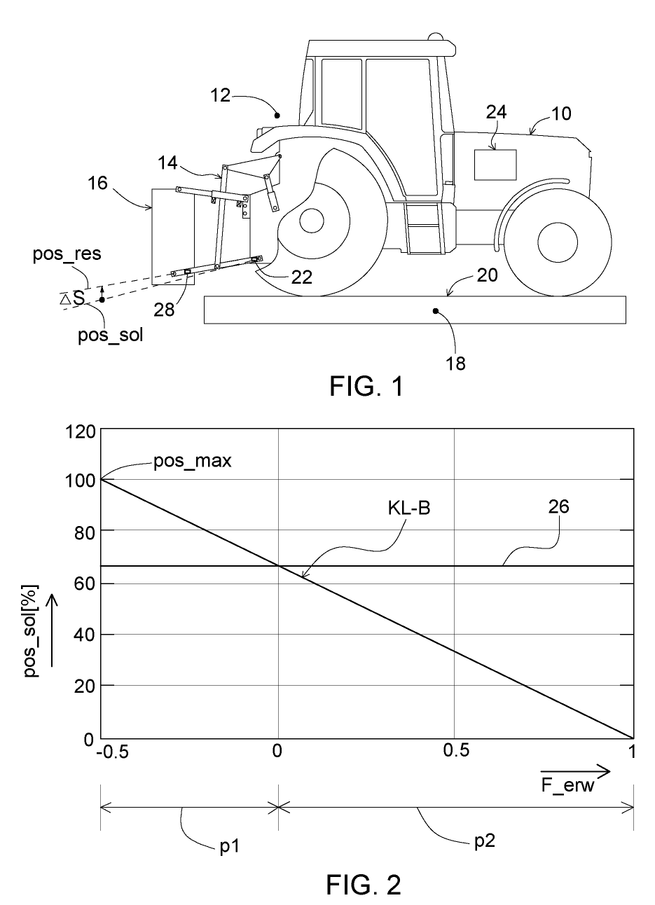

FIG. 1 shows an agricultural utility vehicle 10 in the form of a tractor with a power lift 14 or rear power lift mounted in the rear region 12 thereof. The power lift 14 is coupled to an attachment 16 (illustrated only schematically here) for soil cultivation (for example a plow, harrow). Soil cultivation includes, for example, the creation of a furrow in the soil 18 of an agricultural field 20 with a uniform furrow depth for the planting of seed or plants.

Arranged on the power lift 14 is a force sensor 22, which senses an actual tractive force F_sen currently acting on the power lift 14. The actual tractive force F_sen represents a mechanical resistance of the soil 18 to the attachment 16 or the power lift 14. The signals from the force sensor 22 are fed to a control unit 24 of the utility vehicle 10, which actuates the power lift 14, in particular an actuator (for example lifting cylinder) of the power lift 14, depending on the signals from the force sensor 22 and further signals that will be described below. Thus, the particular height position pos of the power lift 14 can be determined and set by the control unit 24.

FIG. 2 shows a base characteristic curve KL-B, which is provided for carrying out the method according to the disclosure and represents a relationship between a target height position pos_sol, able to be selected by an operator, of the power lift 14 and an expected tractive force F_erw on the power lift 14. For example, the base characteristic curve KL-B is stored in the control unit 24. In the present exemplary embodiment of the base characteristic curve KL-B, the values of the target height positions pos_sol are not specified as absolute values but in percent. Each value of the target height position pos_sol is assigned a predetermined value of the expected tractive force F_erw. This results in the predetermined base characteristic curve KL-B, which has a linear profile in FIG. 2 but, in alternative embodiments, can also have a nonlinear profile at least in some sections. The expected tractive force F_erw is likewise not specified as an absolute value here but as a ratio to an expected maximum tractive force (F_erw = 1).

According to the base characteristic curve KL-B, it is assumed that above a height position of about 66% of the maximum height position pos_max of the power lift 14, there is no engagement of the attachment 16 in the soil 18 and accordingly no positive tractive force on the power lift 14 is determined. It is only at height positions of the power lift 14 lower than the abovementioned 66% of the maximum height position pos_max that a positive tractive force F_erw is expected, i.e. at such height positions of the power lift 14, engagement of the attachment 16 in the soil 18 of the field 20 is assumed. This relationship is also indicated by way of the horizontal field line 26 as a virtual surface of the field 20.

By a position sensor 28 – arranged on the power lift 14, for example, – a height position pos of the power lift 14 can be determined and set, for example the target height position pos_sol selected by the operator or a resulting height position pos_res.

In a phase p1 of the base characteristic curve KL-B, a target height position pos_sol, selected by the operator, of the power lift 14 is set by the control unit 24 in general without any correction of the selected target height position pos_sol. By contrast, in a phase p2 of the base characteristic curve KL-B, i.e. upon engagement of the attachment 16 in the soil 18, adjustment, according to the method, of the height position of the power lift 14 is activated, by way of which a resulting height position pos_res that deviates from the selected target height position pos_sol is able to be determined and set by the control unit 24. In this case, the base characteristic curve KL-B is combined or superimposed with an adjustment characteristic curve KL-R that will be explained below with reference to FIGS. 4 to 8.

By way of example for the technical effect of the height adjustment in phase p2, FIG. 1 indicates that, for the target height position pos_sol, selected by the operator, of the power lift 14, a resulting height position pos_res is determined and set by the control unit 24. A height offset ∆s between the selected target height position pos_sol and the resulting height position pos_res takes into account a force deviation ∆F between a defined target tractive force F_sol and the actual tractive force F_sen determined by the force sensor 22.

As soon as the user has selected the target height position pos_sol, the associated expected tractive force F_erw, which is defined as the target tractive force F_sol, is able to be determined by the base characteristic curve KL-B. As mentioned above, the resulting height position pos_res is determined on the basis of the provided adjustment characteristic curve KL-R. The latter represents a dependence between the resulting height position pos_res and the force deviation ∆F, which results from the difference between the defined target tractive force F_sol and the sensor-determined actual tractive force F_sen.

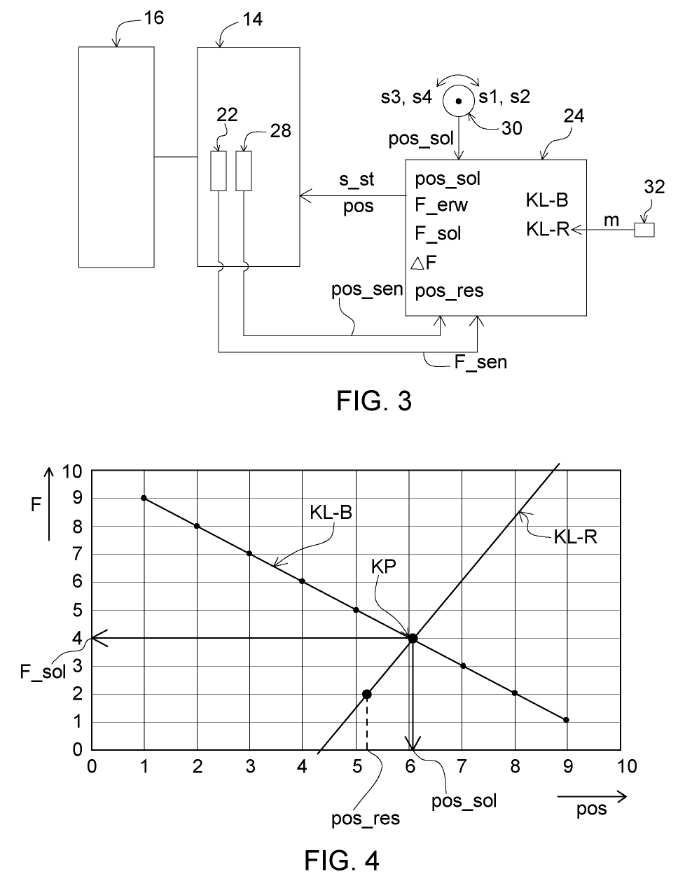

FIG. 3 shows the control unit 24 with different input and output signals, depending on which the power lift 14, in particular an actuator (for example a hydraulic lifting cylinder), is actuated in order to set its height position pos. The height position pos to be set corresponds, for example, to the selected target height position pos_sol or the resulting height position pos_res. Effective input signals are, inter alia, the signals or data from the force sensor 22 and from the position sensor 28 in the region of the power lift 14. By an operating element 30 in the form of a rotatable control wheel, a user or the operator can specify different target height positions pos_sol at the control unit.

The operating element 30 is movable in two directions of rotation such that, by forward and backward rotations, different height positions pos can be specified and can be set on the basis of the characteristic curves KL-B, KL-R. In this case, the operating element 30 is advantageously free of an end stop. Regardless of the current height position pos, a defined forward or backward rotation (for example uniform rotational steps) of the operating element 30 can be carried out in order to bring about a change in the height position pos. In this case, forward rotations also correspond to a desired higher height position pos or always correspond to a desired lower height position pos. For backward rotations, the reverse directional relationship then applies.

In the control unit 24, the base characteristic curve KL-B and the adjustment characteristic curve KL-R are stored. A mathematical gradient m of the adjustment characteristic curve KL-R can be changed via a regulator 32 by the user or operator in order to influence the working result in a desired manner, as is also explained with reference to FIG. 8. At a target height position pos_sol selected or defined by the user or operator, the control unit 24 can determine the force deviation ∆F between the target tractive force F_sol and the actual tractive force F_sen and calculate a resulting height position pos_res that is dependent thereon.

Quite generally, the control unit 24 generates control signals s_st as output signals in order to actuate the power lift 14 so as to set a determined height position pos thereof.

With reference to FIGS. 4 to 8, the adjustment of the height position pos during soil cultivation is described by way of example. The diagrams illustrated in these figures contain different height positions pos and different traction forces F of the power lift 14 as relative values.

The adjustment characteristic curve KL-R represents, in principle, a dependence between the resulting height position pos_res and the established force deviation ∆F and optionally also further criteria. The adjustment effect of the adjustment characteristic curve KL-R is preferably such that the resulting height position pos_res is set to be lower than the selected target height position pos_sol when the actual tractive force F_sen is less than the defined target tractive force F_sol. In this connection, the resulting height position pos_res is furthermore set to be higher than the selected target height position pos_sol when the actual tractive force F_sen is greater than the defined target tractive force F_sol.

In order to determine the resulting height position pos_res, the adjustment characteristic curve KL-R is superimposed on the base characteristic curve. The superimposition is such that the adjustment characteristic curve KL-R intersects the base characteristic curve KL-B at a characteristic curve point KP which corresponds, on the base characteristic curve KL-B, to the selected target height position pos_sol and the defined target tractive force F_sol (FIG. 4). The characteristic curve point KP arises in that the user or the operator, during soil cultivation, visually checks the current working result and selects the target height position pos_sol that seems appropriate, for example by an electronic confirmation signal at the control unit 24. By selecting the target height position pos_sol, the target tractive force F_sol and consequently also the characteristic curve point KP are automatically defined via the provided base characteristic curve KL-B for the application of the adjustment characteristic curve KL-R.

Depending on the established force deviation ∆F between the target tractive force F_sol and the sensor-determined actual tractive force F_sen and optionally depending on further criteria, the resulting height position pos_res is determined using the adjustment characteristic curve KL-R. The control unit 24 accordingly actuates the power lift 14 in order to set the determined resulting height position pos_res.

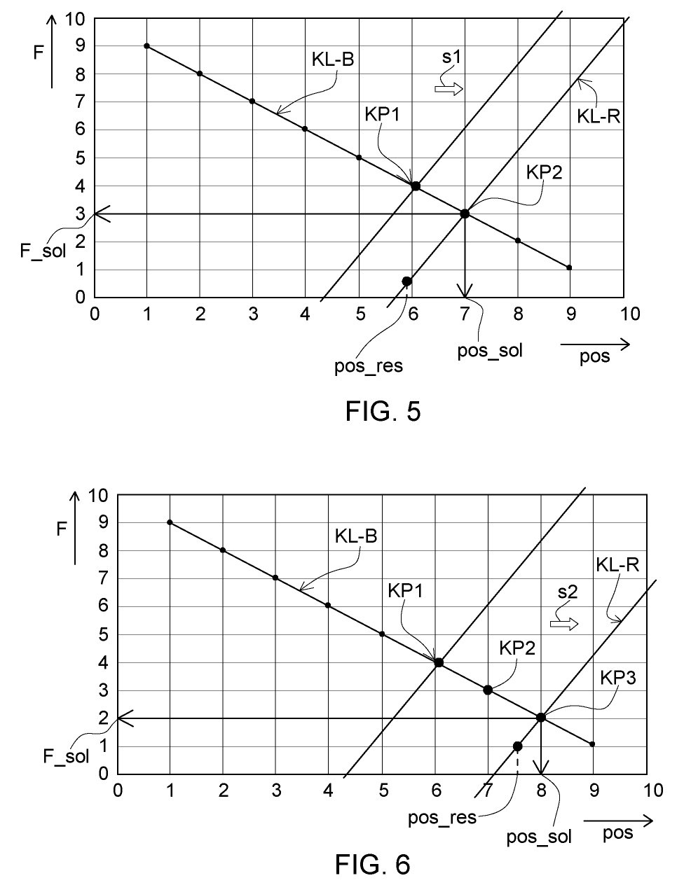

In FIG. 5, the target height position pos_sol selected according to FIG. 4 is changed by one rotational forward step s1 of the operating element 30. As a result, the position of the characteristic curve point KP along the base characteristic curve KL-B changes. In other words, the adjustment characteristic curve KL-R is then no longer applied at the original characteristic curve point KP1 according to FIG. 4 but at the changed characteristic curve point KP2. Accordingly, via the new characteristic curve point KP2 in FIG. 5, the selected target height position pos_sol is changed and a changed target tractive force F_sol is defined. Again, depending on the currently established force deviation ∆F between the target tractive force F_sol and the sensor-determined actual tractive force F_sen and optionally depending on further criteria, a changed resulting height position pos_res is determined using the adjustment characteristic curve KL-R.

FIG. 6 shows a selected target height position pos_sol changed by a further forward step s2 compared with FIG. 5. Depending on the currently determined force deviation ∆F and optionally depending on further criteria, a further changed resulting height position pos_res is determined and set by means of the control unit 24.

While the forward steps s1, s2 bring about a higher resulting height position pos_res, a lower resulting height position pos_res can be set by actuating the operating element 30 in the reverse direction of rotation.

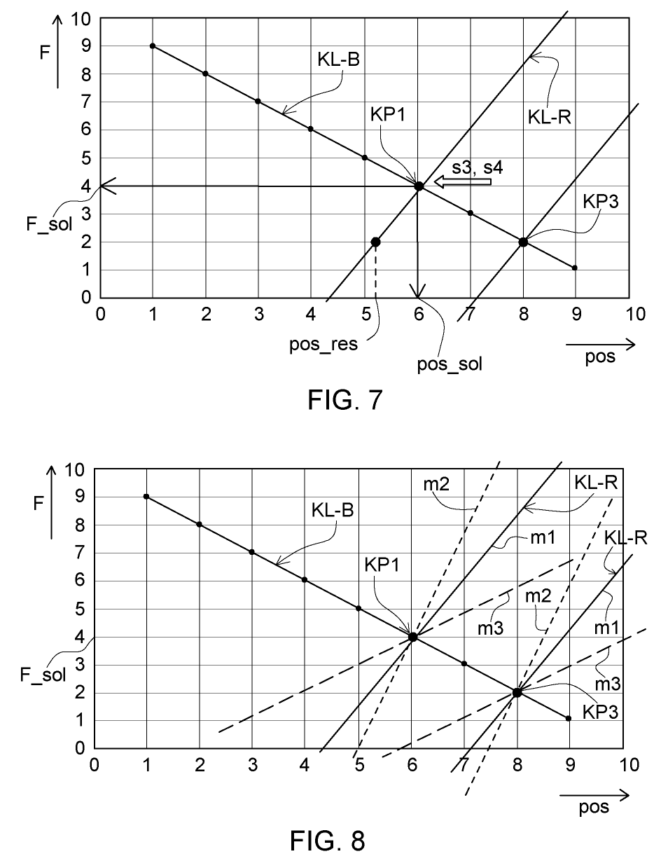

FIG. 7 shows a reversal of the changed resulting height position pos_res according to FIG. 6. In this case, by way of two backward steps s3, s4, the target height position pos_sol according to FIG. 4 is selected again and – given soil conditions that have remained similar to constant – the resulting height position pos_res from before the change according to FIGS. 5 and 6 is also determined.

FIG. 8 shows once again the base characteristic curve KL-B and the superimposed adjustment characteristic curve KL-R, which can be effective depending on differently selected target positions pos_sol or different characteristic curve points KP, as has already been explained by way of example by the characteristic curve points KP1, KP2, KP3 in FIGS. 4 to 7. FIG. 8 indicates that the gradient m of the adjustment characteristic curve KL-R is changeable by the user or operator by the regulator 32 in order to influence or optimize the desired working result in the field 20. For example, an originally set gradient m1 can be changed by a gradient m2 or m3 or by a different gradient value.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for setting a height position of a power lift mounted on a utility vehicle and coupled to an attachment for soil cultivation, the method comprising:
providing a base characteristic curve , which represents a relationship between a target height position of the power lift and a tractive force expected on the power lift,
expecting the tractive force for a selected target height position defined as a target tractive force by the base characteristic curve, and
determining and setting a resulting height position of the power lift depending on the target tractive force and an actual tractive force sensed at the power lift.

2. The method of claim 1, wherein the resulting height position is determined on the basis of a provided adjustment characteristic curve which represents a relationship between the resulting height position and a deviation of the target tractive force from the actual tractive force.

3. The method of claim 2, wherein the adjustment characteristic curve intersects the base characteristic curve at a characteristic curve point which corresponds, on the base characteristic curve, to the selected target height position and the defined target tractive force.

4. The method of claim 2, comprising involving a relationship of the adjustment characteristic curve such that the resulting height position is set to be lower than the selected target height position when the actual tractive force is less than the target tractive force and is set to be higher than the selected target height position when the actual tractive force is greater than the target tractive force.

5. The method of claim 2, wherein a gradient of the adjustment characteristic curve is changeable.

6. The method of claim 1, wherein the selected target height position is changeable by an operating element.

7. The method of claim 6, wherein the selected target height position is changeable incrementally by at least one forward step of the operating element.

8. The method of claim 7, wherein, starting from a changed resulting height position set by at least one forward step, the resulting height position from before the change is able to be set again by a number of backward steps of the operating element that corresponds to the number of forward steps.

9. A utility vehicle on which a power lift is mounted, which is coupled to an attachment for soil cultivation, comprising:
a force sensor for sensing an actual tractive force on the power lift, and
a control unit for setting a height position of the power lift such that
(i) a base characteristic curve is provided, which represents a relationship between a target height position of the power lift and a tractive force expected on the power lift,
(ii) the tractive force for a selected target height position, expected by the base characteristic curve, is defined as a target tractive force, and
(iii) a resulting height position of the power lift is determined and set, depending on the target tractive force and the actual tractive force.

10. The utility vehicle of claim 9, further comprising an operating element for changing the selected target height position.

11. The utility vehicle of claim 10, wherein the operating element is in the form of a rotatable control wheel.

12. The utility vehicle of claim 11, wherein the rotatability of the control wheel is free of an end stop.

13. The utility vehicle of claim 9, wherein the power lift is in the form of a rear power lift.

14. The utility vehicle of claim 9 , wherein the utility vehicle is an agricultural utility vehicle.
